(19) United States
(12) Patent Application Publication
(10) Pub. No.: US 2013/0302024 A1
(43) Pub. Date: Nov. 14, 2013

(54) OVERHEAD SURVEILLANCE SYSTEM AND COMPONENTS THEREFOR

(71) Applicant: SENTRY TECHNOLOGY CORPORATION, Ronkonkoma, NY (US)

(72) Inventors: Matthew Cowles Eckert, Hauppauge, NY (US); Christopher James Zwettler, Stillwater, MN (US)

(73) Assignee: SENTRY TECHNOLOGY CORPORATION, Ronkonkoma, NY (US)

(21) Appl. No.: 13/829,969

(22) Filed: Mar. 14, 2013

Related U.S. Application Data
(60) Provisional application No. 61/645,802, filed on May 11, 2012.

(51) Int. Cl. G03B 17/56

(52) U.S. Cl. CPC G03B 17/561
USPC 396/427

(57) ABSTRACT

A railway for an overhead camera surveillance system comprises a track comprising a plurality of flexible track segments joined end-to-end, the track being configured to define at least one rail along which at least one motorized camera carriage suspended therefrom is moveable.

### CROSS-REFERENCE TO RELATED APPLICATION

This application claims the benefit of U.S. Provisional Application No. 61/645,802 to Eckert et al. filed on May 11, 2012, entitled “Overhead Surveillance System and Components Therefor”, the entire disclosure of which is incorporated herein by reference.

### FIELD OF THE INVENTION

The present invention relates generally to camera surveillance and in particular, to an overhead surveillance system and components therefor.

### BACKGROUND OF THE INVENTION

Camera surveillance systems are well known in the art and are employed in a variety of environments for security purposes such as for example, to guard against theft, unlawful entry etc. In-store surveillance systems capture video images at different locations within the stores that are being monitored allowing on-floor security personnel to be alerted when theft and/or damage attempts are being made. Some in-store surveillance systems employ cameras mounted at fixed locations within the stores that are rotatable to image the surrounding areas adjacent the cameras. Other in-store surveillance systems employ cameras that are moveable along tracks to image different areas of the stores. Although these latter surveillance systems typically reduce the number of cameras that are required to image the stores, the track designs have limited the movement paths of the cameras. As a result, in larger stores, multiple track and camera assemblies have been required.

As will be appreciated, improvements are desired. It is therefore an object to provide a novel overhead surveillance system and novel components therefor.

### SUMMARY OF THE INVENTION

Accordingly, in one aspect there is provided a railway for an overhead camera surveillance system comprising a track comprising a plurality of flexible track segments joined end-to-end, said track being configured to define at least one rail along which at least one motorized camera carriage suspended therefrom is moveable.

The flexible track segments may be joined end-to-end to form a closed loop or an open length of track. When joined end-to-end to form an open length of track, the open length of track may be curved or straight or may comprise both curved and straight sections. In one embodiment, the track is further configured to accommodate conductors. In one form, the conductors are accommodated by and press-fit into laterally spaced channels that extend along opposite sides of a camera carriage running surface. A junction may be provided along the track at which the conductors are interrupted.

In one embodiment, the flexible track segments are formed of plastic material and comprise straight track segments and curved track segments. The at least one rail comprises a pair of outwardly diverging side surfaces along which guide wheels of the at least one motorized camera carriage run to maintain the camera carriage generally centered on the track. An alignment element acts between each adjacent pair of flexible track segments. In one form, the track is configured to define a hollow monorail. Each alignment element is a plug accommodated by its respective pair of adjacent flexible track segments.

In one embodiment, the railway further comprises a housing surrounding the track. In one form, the housing comprises depending sidewalls positioned on opposite sides of the track and a flexible window element extending between the sidewalls. The window element may be mirrored or tinted. Hangers on the sidewalls may be used to suspend the window element from the sidewalls.

In one embodiment, the railway further comprises the at least one motorized camera carriage. In one form, the at least one camera carriage is biased into engagement with the track and has two sets of spaced guide wheels thereon, each set of guide wheels running along a respective one of the diverging side surfaces. The guide wheels of at least one of the sets may be moveable between side surface engaging and disengaging conditions to facilitate installation and removal of the at least one camera carriage on and from the at least one rail of the track. A camera assembly is mounted on the camera carriage and in one form, is a pan, tilt and zoom (PTZ) camera.

According to another aspect there is provided a housing for an overhead camera surveillance system railway comprising downwardly extending sidewalls positioned on opposite sides of an overhead track along which at least one motorized camera carriage is moveable; and a window element formed of flexible film material, said window element extending between and being suspended from said sidewalls.

According to yet another aspect there is provided a camera carriage for an overhead surveillance system comprising a chassis and guide wheel sets on said chassis, each guide wheel set being positioned to engage an opposite side of a rail of said surveillance system, at least one of said guide wheel sets being moveable between engaging and disengaging conditions to facilitate installation and removal of said camera carriage on and from said rail.

### BRIEF DESCRIPTION OF THE DRAWINGS

Embodiments will now be described more fully with reference to the accompanying drawings in which:

FIG. 1 is a bottom plan view of a railway for an overhead surveillance system;

FIG. 2 is an end view of a track segment and a camera assembly suspended from the track segment that form part of the railway of FIG. 1;

FIG. 3 is a perspective view of the track segment and a camera carriage suspended from the track segment that forms part of the camera assembly of FIG. 2;

FIG. 4 is an end view of the track segment and camera carriage of FIG. 3;

FIGS. 4a to 4c are perspective, end and bottom plan views, respectively, of a portion of the camera carriage of FIG. 3 in an engaging condition;

FIGS. 4d and 4e are perspective and end views, respectively, of the camera carriage portion of FIGS. 4a to 4c in a disengaging condition;

FIG. 5 is an exploded perspective view of two adjacent track segments positioned at a junction along the railway track;

FIG. 6 is a side view of the track segment and camera assembly of FIG. 2;

FIG. 7 is an end view of the track segment and camera assembly of FIG. 2 surrounded by a housing;

FIG. 8 is a perspective view of a portion of a track segment and the housing;

FIG. 9 is an end view of the track segment and housing of FIG. 8; and

FIGS. 10 and 11 are end and perspective views, respectively, showing a hanger fitted onto a sidewall of the housing.

### DETAILED DESCRIPTION OF THE EMBODIMENTS

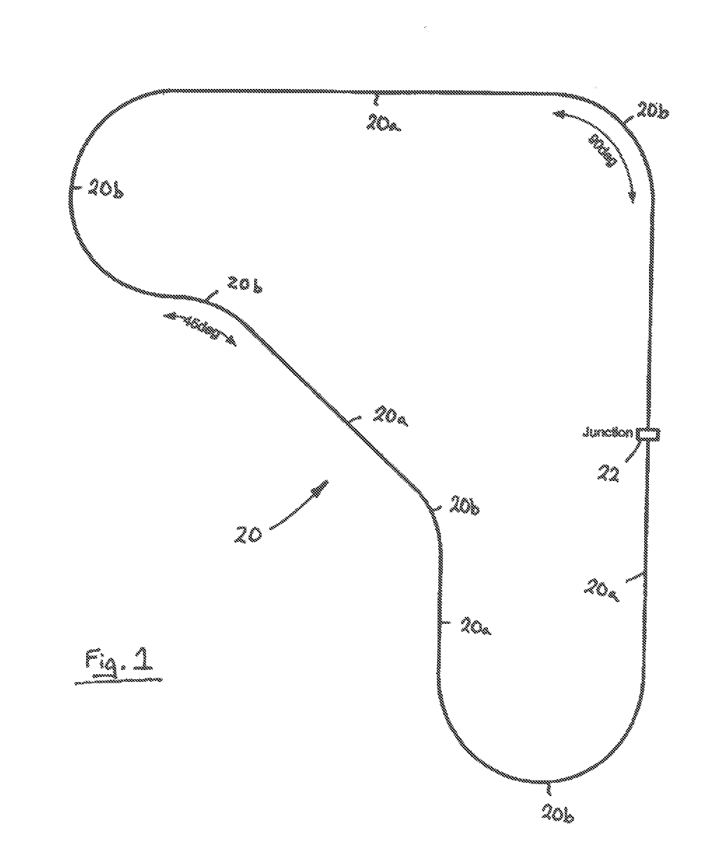

Turning now to FIG. 1, a railway for an overhead camera surveillance system is shown. As can be seen, the railway is installed above a location to be monitored. In this embodiment, the railway comprises a track 20 having a plurality of straight portions or sections 20a and a plurality of curved portions or sections 20b that form a closed loop. A junction 22 is provided along the track 20. Although the degree of curvature of some of the curved portions 20b in FIG. 1 is identified, those of skill in the art will appreciate that the curved portions 20b may have other degrees of curvature and that the arrangement of straight and curved portions 20a and 20b forming the track 20 will be selected to best suit the environment to be monitored.

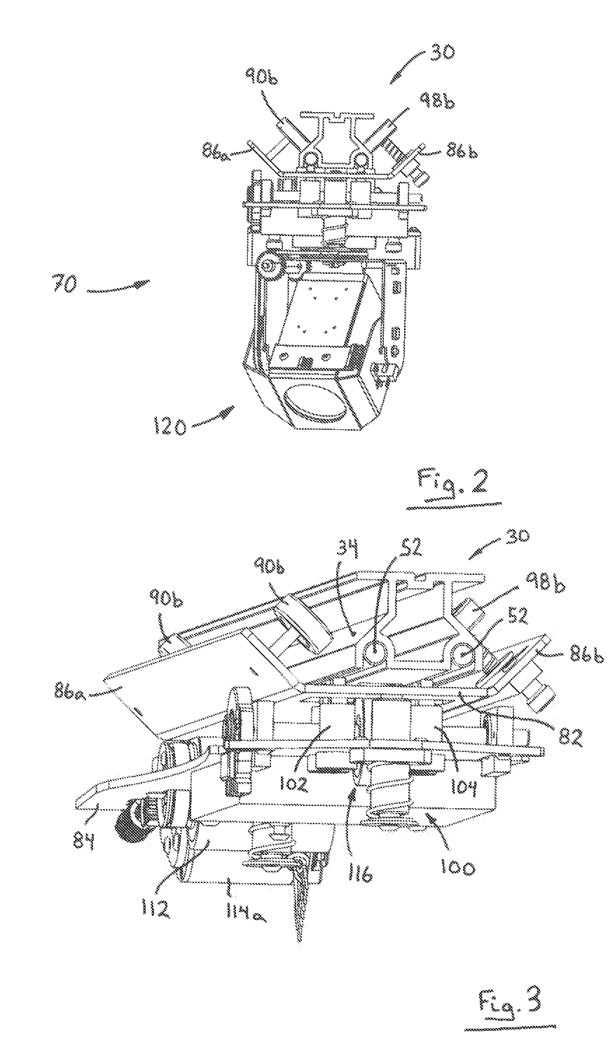

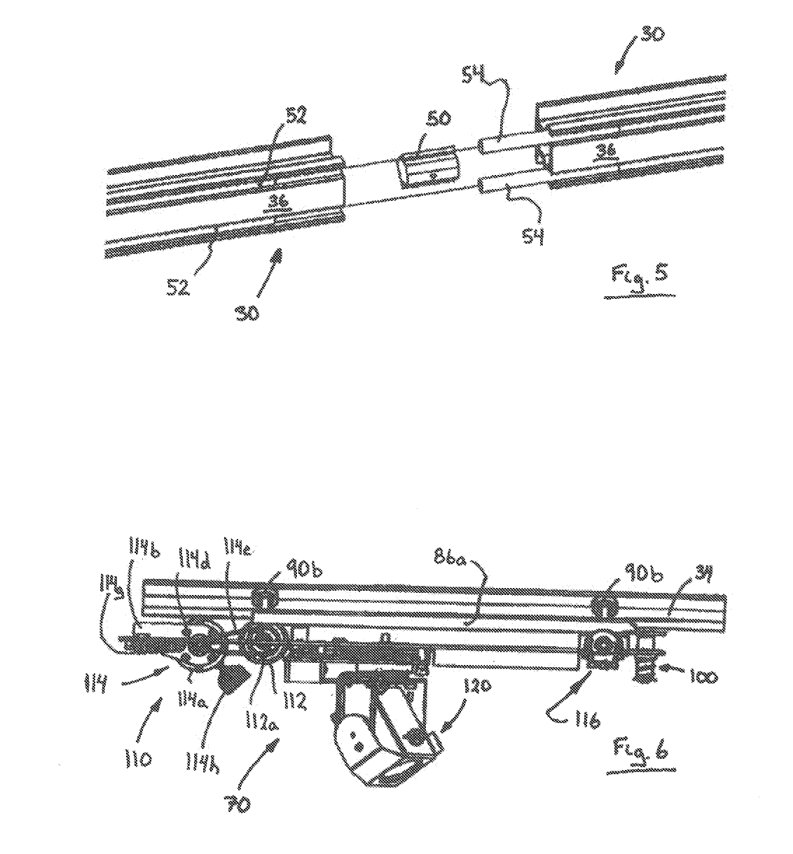

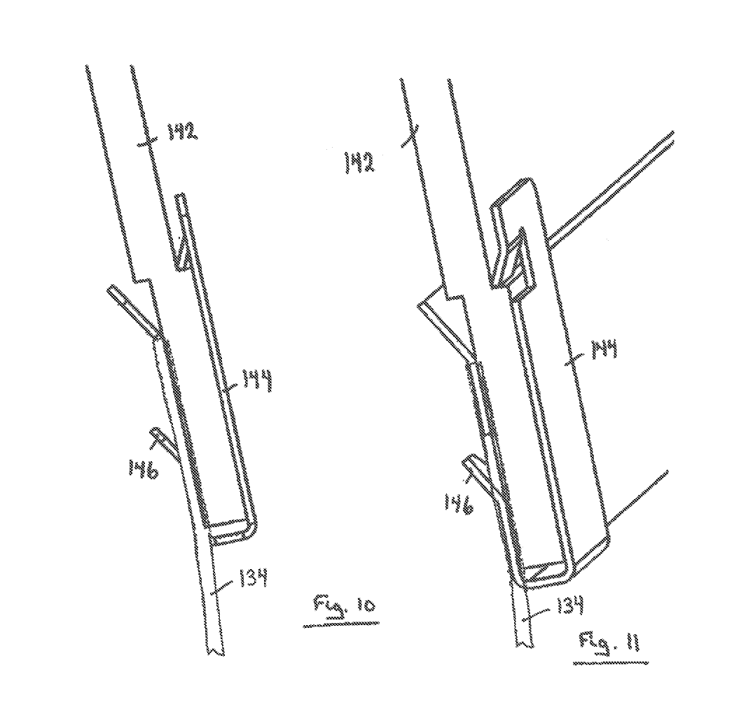

The track 20 comprises a plurality of track segments 30 formed of flexible dielectric plastic or other suitable non-conductive material that are joined end-to-end (best seen in FIG. 5). In this embodiment, each track segment 30 is extruded from non-conductive polypropylene which is inexpensive and flexible allowing the track segment 30 to be shaped into arched corners and curves, as desired. FIGS. 2 to 4, 8 and 9 best illustrate one of the track segments 30. As can be seen, each track segment 30 is configured to define a hollow monorail. The hollow monorail is shaped to define a pair of outwardly diverging, exterior side guide surfaces 34 and a bottom camera carriage running surface 36. Channels 38 and 40 extend along opposite sides of the bottom camera carriage running surface 36.

Each abutting pair of track segments 30 is joined by an alignment element 50 in the form of a plug that is accommodated by and spans the adjacent track segments 30 as shown in FIG. 5. The alignment elements 50 help to maintain the track segments 30 forming the track 20 in vertical and horizontal alignment while also adding strength and stability to the structure of the track 20.

Power and video data conductors 52 formed of copper or other suitable conductive material are press-fitted into the aligned channels 38 and 40 of the track segments 30 and extend substantially the length of the closed track loop. Insulating spacers 54 are however, accommodated by the channels 38 to 40 at the junction 22 thereby to interrupt the power and video data conductors 52. As will be appreciated, the flexible nature of the track segments 30 facilitates installation of the power and video data conductors 52 into the channels 38 and 40.

A camera assembly 70 is suspended from the track 20 and is moveable along the track 20 thereby to allow video images of the monitored location to be captured. As the track 20 forms a closed loop, the camera assembly 70 is able to move along the track 20 continuously in either direction avoiding the need for the camera assembly 70 to stop at any termination point along the track and reverse direction. This avoids situations where the camera assembly 70 is stopped at one side of a termination point and then moved in the opposite direction a long distance only to arrive at a location that is a short distance from the opposite side of the termination point.

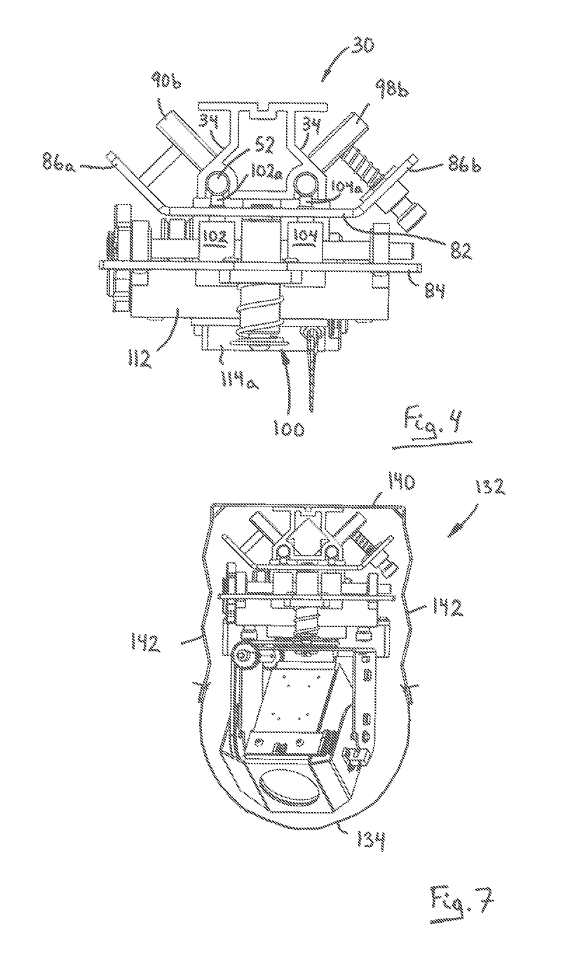

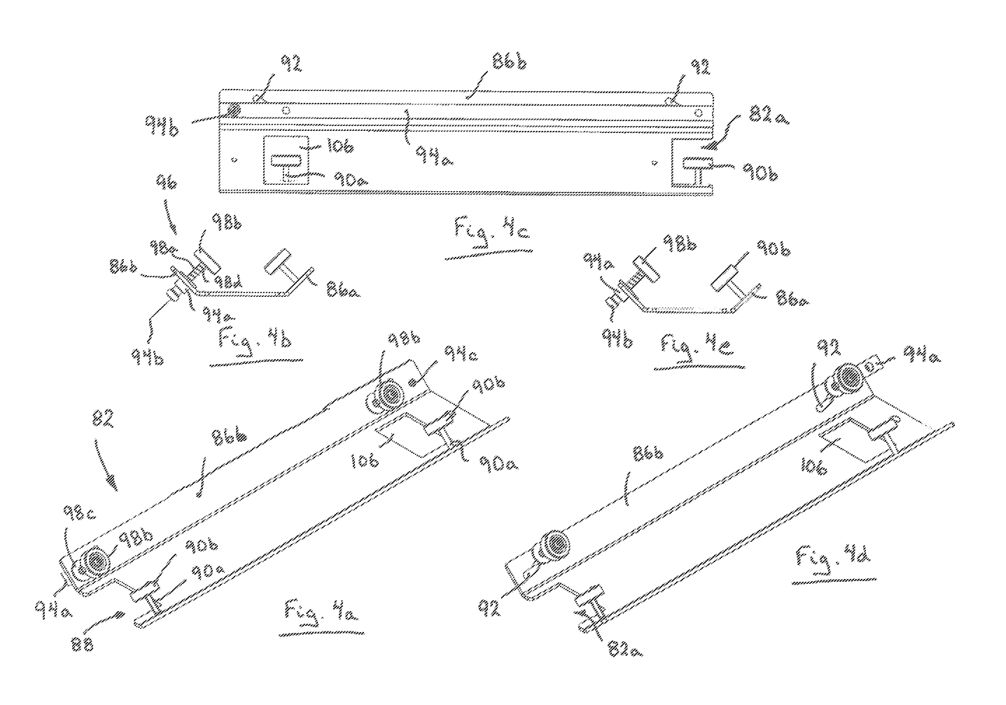

In this embodiment, the camera assembly 70 comprises a camera carriage 80 best shown in FIGS. 3 and 4. The camera carriage 80 has a chassis comprising a pair of vertically spaced, metal plates 82 and 84. The upper metal plate 82 is shown in FIGS. 4a to 4e and comprises upwardly angled portions or wings 86a and 86b that extend along its opposite sides. Angled portion 86a supports a pair of guide wheel assemblies 88 on its upper surface. The guide wheel assemblies 88 are positioned adjacent opposite ends of the angled portion 86a. Each guide wheel assembly 88 comprises a post 90a fixedly mounted to the angled portion 86a and a rotatable guide wheel 90b mounted on the distal end of the post 90a. The angled portion 86b has a pair of arcuate or curved slots 92 formed therein with the slots being positioned adjacent opposite ends of the angled portion 86b. An elongate bar 94a extends along the bottom surface of the angled portion 86b and has a release screw 94b thereon that engages a threaded hole 94c in the angled portion 86b. The elongate bar 94a also supports a pair of guide wheel assemblies 96 that are aligned with the slots 92. Each guide wheel assembly 96 comprises a post 98a fixedly mounted to the elongate bar 94a that extends through its respective slot 92, a rotatable guide wheel 98b mounted on the distal end of the post 98a, a washer 98c surrounding the post 98a and a biasing element 98d in the form of a spring that surrounds the post 98a and bears against the guide wheel 98b and washer 98c to force the washer 98c against the upper surface of the angled portion 86b.

In an engaging condition during normal use, as shown in FIGS. 4a to 4c, the elongate bar 94a is positioned relative to the angled portion 86b such that the release screw 94b is aligned and threadably engaged with the threaded hole 94c thereby to retain the elongate bar 94a in that position. In this position, the guide wheel assemblies 96 are positioned adjacent the lower ends of the slots 92. As a result, the guide wheels 90b and 98b of the guide wheel assemblies 88 and 96 bear against the outwardly angled side guide surfaces 34 of the track segments 30 thereby to maintain the upper metal plate 82 generally centered with respect to the camera carriage running surface 36.

The use of the elongate bar 94a to support the guide wheel assemblies 96 and the provision of the arcuate slots 92 in the angled portion 86b facilitate removal of the camera carriage 80 from the track 20 as well as its installation on the track 20. For example, in order to remove the camera carriage 80 from the track 20, the release screw 94b is disengaged from the threaded hole 94c allowing the elongate bar 94a to move relative to the angled portion 86b. Once released, the angled bar 94a is moved relative to the angled portion 86b so that the guide wheel assemblies 96 are positioned adjacent the upper ends of the slots 92 as shown in FIGS. 4d and 4e. In this disengaging position, the guide wheels 98b of the guide wheel assemblies 96 are positioned above the adjacent guide surface 34 of the track segments 34 a sufficient distance to provide clearance between the guide wheels 98b and track 20 and allow the camera carriage 80 to be tilted downwardly and removed from the track 20. During installation of the camera carriage 80, opposite steps in reverse order are performed.

The lower metal plate 84 is mounted to the upper metal plate 82 by longitudinally spaced spring assemblies 100 that bias the upper and lower metal plates 82 and 84 towards one another. The lower metal plate 84 supports two pair of brush blocks 102 and 104. The brush block 102 of each pair extends through an opening 106 in the upper metal plate 82 and comprises a pair of spaced conductive bars 102a that contacts the power and video data conductor 52 press-fitted into aligned channels 38. The brush block 104 of each pair also extends through the opening 106 in the upper metal plate 82 and comprises a pair of conductive spaced bars 104a that contacts the power and video data conductor 52 press-fitted into aligned channels 40. The longitudinal spacing of the pairs of brush blocks 102 and 104 is chosen so that when the camera carriage 80 traverses the insulating spacers 54 interrupting the power and video data conductors 52, at least one pair of brush blocks 102 and 104 remains in contact with the power and video data conductors 52. The length of the camera carriage 80 in conjunction with the configuration of the track segments 30 are selected to allow the camera assembly 70 to manoeuvre easily around corners with the desired stability providing for smooth camera assembly travel along the track 20. This helps to ensure good quality video image capture that is substantially free of distortion caused by excessive vibration.

In this embodiment, a pan, tilt and zoom (PTZ) camera 120 best shown in FIGS. 2, 6 and 7 is mounted on the lower metal plate 84. The PTZ camera 120 comprises a controller and drive mechanisms (not shown) that are responsible for operating the PTZ camera 120 in response to an external controller. Power drawn from the energized power and video data conductors 52 via one or more of the brush block pairs in contact therewith is used by the controller of the PTZ camera 120 to operate the PTZ camera drive mechanisms and to advance the camera assembly 70 along the track 20, as required. Video images acquired by the PTZ camera 120 are output by the controller onto the power and video data conductors 52 for conveyance to the external controller via one or more of the brush block pairs 102 and 104. As PTZ cameras are well known in the art, further specifics of the PTZ camera 120 and its drive mechanisms will not be described further herein.

A drive wheel assembly 110 best seen in FIG. 6 is mounted on the lower metal plate 84 adjacent one end thereof. The drive wheel assembly 110 comprises a drive wheel 112 that passes through a notch 82a formed in the upper plate 82 and bears against the camera carriage running surface 36 and a motor assembly 114 that is configured to drive the drive wheel 112 thereby to allow the camera carriage 80 to advance along the track 20. In this embodiment, motor assembly 114 comprises a motor 114a mounted to a bracket 114b that is coupled to the lower metal plate 84. The shaft of motor 114a passes through the bracket 114b and has a pulley wheel 114d thereon. An endless drive belt 114e is wound around the pulley 114d and a pulley wheel 112a on the drive wheel 112. A spring 114g acts between the bracket 114b and the lower metal plate 84 to maintain drive belt tension. A power connection 114h is also provided and receives power from the controller of the PTZ camera 120. As will be appreciated, because the spring assemblies 100 bias the upper and lower metal plates 82 and 84 together and the upper metal plate 82 is suspended from the outwardly diverging side guide surfaces 34 by the guide wheels 90, the spring assemblies 100 pull the drive wheel 112 and brush blocks 102 and 104 into secure contact with the camera carriage running surface 36 and power and video data conductors 52, respectively. An optical disk encoder 116 or other suitable position determining device is also mounted on the lower metal plate 84 adjacent its other end to allow the position of the camera carriage 80 along the track 20 to be readily determined.

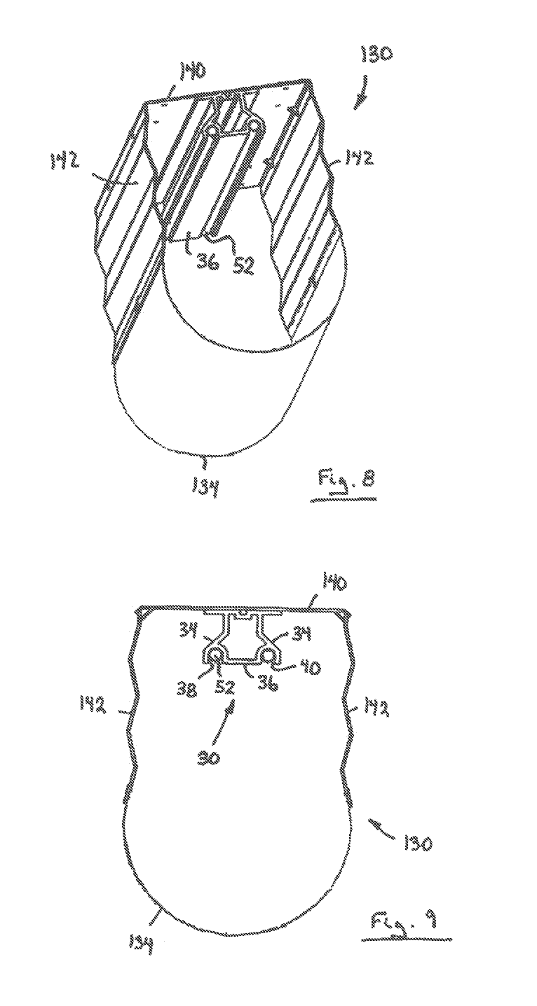

In order to obscure the camera assembly 70 from view thereby to inhibit an onlooker from determining the position of the camera assembly 70 along the track 20, a housing 130 shown in FIGS. 7 to 11 is employed to surround the track 20. As can be seen, the housing comprises a cap 132 formed of aluminum, steel, plastic or other suitable structural material and a window element 134 suspended from the cap 132. The cap 132 comprises a generally planar, longitudinally extending upper top plate 140 to which the assembled track 20 is suitably fastened via self-tapping screws, rivets, adhesive or other suitable fastening means and sidewalls 142 that extend downwardly from opposite sides of the top plate 140. The upper top plate 140 is secured directly to the ceiling surface by fasteners, adhesive or other suitable fastening means. Hangers or clips 144 are press-fit onto and frictionally engage the bottom edges of the sidewalls 142 at longitudinally spaced locations therealong. Each hanger 144 comprises an upwardly angled projection 146 on its interior facing surface.

As best seen in FIGS. 10 and 11, the window element 134 spans the sidewalls 142 of the cap 132 and is suspended from the hangers 144. In particular, perforations, slots, holes or the like are provided in the window element 134 through which the projections 146 of the hangers 144 pass. In this embodiment, the window element 134 is formed of light-weight flexible glycol-modified polyethylene terephtalate (PETG) film material that is mirrored or tinted so that the track 20 is not visible when looking upwardly at the track. As will be appreciated, the window element 134 has an aesthetic tear-drop shape. Also, since the upper ends of the window element 134 are positioned within the sidewalls 142 of the cap 132, the housing 130 is water-resistant allowing the track 20 to be used in both indoor and outdoor environments.

As described above, the housing 130 assists in inhibiting an onlooker from determining the location of the camera assembly 70 along the track 20 and provides a water-resistant environment for the track. Depending on the environment, the housing 130 however, need not be employed. For example, the track 20 may be secured directly to the ceiling surface or may be suspended from the ceiling surface by hangers without using a housing allowing the track and camera assembly to remain in view. Alternatively, in these instances, a window element on its own may be hung from the ceiling surface around the track to obscure the track and camera assembly from view.

Although the track is described as supporting a single camera assembly 70, those of skill in the art will appreciate that multiple camera assemblies may be supported by the track 20. Also, each camera assembly need not comprise a PTZ camera. Other types of cameras may be employed.

In the embodiment described above, the track segments 30 are configured such that the track 20 forms a closed loop. Those of skill in the art will however appreciate that other track configurations are possible. For example, the track segments 30 may be joined end-to-end to form an open length of track that is either straight or curved or alternatively, an open length of track that comprises both curved and straight portions.

Although the elongate bar is described as having a single release screw thereon, those of skill in the art will appreciate that the elongate bar may accommodate more than one release screw. Those of skill in the art will also appreciate that alternative releasable retainer configurations may be employed to hold the elongate bar in position when in the engaging condition. Furthermore, although only one set of guide wheels is shown and described as being moveable between engaging and disengaging conditions, if desired, both sets of guide wheels may be moveable between engaging and disengaging conditions.

In the embodiments described above, the camera assembly 70 draws power from the power and video data conductors 52 press-fitted into the aligned channels 38 and 40 and video images acquired by the camera assembly 70 are output on to the power and video data conductors 52 for conveyance to the external controller. Alternative configurations are of course possible. If desired, the camera assembly 70 may comprise a wireless transmitter or wireless transceiver allowing acquired video images to be transmitted to the external controller wirelessly. As will be appreciated, this arrangement obviates the need for conveying video images over the conductors 52. The camera assembly 70 may also comprise an onboard power supply. If the camera assembly 70 draws power from the conductors, the onboard power supply acts as a backup power supply to power the camera assembly 70 in the event of power interruption to the conductors 52. Alternatively, if the camera assembly 70 does not draw power from the conductors, the onboard power supply is responsible for providing the necessary operating power for the camera assembly 70. In this embodiment, if the camera assembly 70 also employs a wireless transceiver or a separate wireless transmitter and receiver, the power and video data conductors and aligned channels in the track can be eliminated.

Although embodiments have been described with reference to the drawings, those of skill in the art will appreciate that variations and modifications may be made without departing from the scope of the invention as defined by the appended claims.

What is claimed is:

1. A railway for an overhead camera surveillance system comprising:
a track comprising a plurality of flexible track segments joined end-to-end, said track being configured to define at least one rail along which at least one motorized camera carriage suspended therefrom is moveable.

2. A railway according to claim 1 wherein said track is further configured to accommodate conductors.

3. A railway according to claim 2 wherein said conductors are accommodated by laterally spaced channels formed in said track.

4. A railway according to claim 3 wherein said conductors are press-fit into said channels.

5. A railway according to claim 3 or 4 wherein said channels extend along opposite sides of a camera carriage running surface.

6. A railway according to claim 1 wherein said at least one rail comprises a pair of outwardly diverging side surfaces along which guide wheels of the at least one motorized camera carriage run.

7. A railway according to claim 1 wherein said flexible track segments are formed of plastic material.

8. A railway according to claim 7 wherein said track is configured to define a hollow monorail.

9. A railway according to claim 8 further comprising an alignment element acting between each adjacent pair of flexible track segments.

10. A railway according to claim 9 wherein each alignment element is a plug accommodated by and spanning its respective pair of adjacent flexible track segments.

11. A railway according to claim 2 further comprising a junction along said track at which said conductors are interrupted.

12. A railway according to claim 1 further comprising a housing surrounding said track.

13. A railway according to claim 12 wherein said housing comprises depending sidewalls positioned on opposite sides of said track and a flexible window element extending between said sidewalls.

14. A railway according to claim 13 wherein said window element is mirrored or tinted.

15. A railway according to claim 13 further comprising hangers at spaced locations along said sidewalls upon which said window element is suspended.

16. A railway according to claim 15 wherein said hangers releasably engage said sidewalls.

17. A railway according to claim 16 wherein each of said hangers comprises at least one upwardly and inwardly extending formation thereon to pass through a respective perforation, slot or hole in said window element.

18. A railway according to claim 1 further comprising the at least one motorized camera carriage.

19. A railway according to claim 18 wherein said at least one camera carriage is biased into engagement with said at least one rail.

20. A railway according to claim 19 wherein said at least one camera carriage comprises a guide arrangement to maintain said camera carriage generally centered on said at least one rail.

21. A railway according to claim 20 wherein said guide arrangement comprises a pair of guide wheel sets, each guide wheel set being positioned adjacent an opposite side of said rail, the guide wheels of each set engaging said respective side of said at least one rail.

22. A railway according to claim 21 wherein at least one of said guide wheel sets is moveable between side engaging and disengaging conditions to facilitate installation and removal of said at least one camera carriage on and from the at least one rail.

23. A railway according to claim 18 further comprising a camera assembly mounted on said camera carriage.

24. A railway according to claim 23 wherein said camera assembly comprises a pan, tilt and zoom camera.

25. A railway according to claim 1 wherein said track forms a closed loop and comprises curved track sections or curved and straight track sections.

26. A railway according to claim 1 wherein said flexible track segments comprise straight track segments and/or curved track segments.

27. A housing for an overhead camera surveillance system railway comprising:
downwardly extending sidewalls positioned on opposite sides of an overhead track along which at least one motorized camera carriage is moveable; and
a window element formed of flexible film material, said window element extending between and being suspended from said sidewalls.

28. A housing according to claim 27 wherein said window element is mirrored or tinted.

29. A housing according to claim 27 further comprising hangers at spaced locations along said sidewalls upon which said window element is suspended.

30. A housing according to claim 29 wherein said hangers releasably engage said sidewalls.

31. A housing according to claim 30 wherein each of said hangers comprises at least one upwardly and inwardly extending formation thereon to pass through a respective perforation in said window element.

32. A housing according to claim 27 wherein said sidewalls are formed of metal, plastic or other suitable material.

33. A camera carriage for an overhead surveillance system comprising a chassis and guide wheel sets on said chassis, each guide wheel set being positioned to engage an opposite side of a rail of said surveillance system, at least one of said guide wheel sets being moveable between engaging and disengaging conditions to facilitate installation and removal of said camera carriage on and from said rail.

34. A camera carriage according to claim 33 wherein said chassis is biased into engagement with said rail.
